(19) United States
(12) Patent Application Publication
(10) Pub. No.: US 2005/0086632 A1
(43) Pub. Date: Apr. 21, 2005

(54) Interface method for a device driver

(76) Inventor: Hiroshi Oyama, Niwa-gun (JP)

Correspondence Address: Matthew E. Connors, Esq.;Gauthier & Connors LLP, Suite 3300, 225 Franklin Street, Boston, MA, 02110, US

(21) Appl. No.: 10/953,308

(22) Filed: Sep. 29, 2004

(30) Foreign Application Priority Data
Oct. 1, 2003 (JP) 2003-343279

(51) Int. Cl. G06F 9/44

(52) U.S. Cl. 717/100; 719/321

(57) ABSTRACT

An interface method for a device driver for enabling a function call initiated by an application program and addressed to a device driver side, and the reverse. The present invention provides a means for perform device control in an operation system in which an application program and a device driver are stored in different memory spaces. The operation control is achieved utilizing a method for enabling a function call, using an IDL (interface definition language), initiated from an application program and addressed to a dynamic link library. The present invention additionally provides a means for enabling a function call initiated from a device driver and addressed to an application program. According to the present invention, an interface for device control is defined using an IDL, and a program for relaying a function call between an application program and a device driver is provided so as to enable a function call initiated by an application program and addressed to the device drive, and vice versa. The relay program is automatically created using a special IDL compiler.

### CROSS-REFERENCE TO RELATED APPLICATION(S)

The entire disclosure of Japanese Application No. 2003-343279 including specification, claims, drawings and abstract is incorporated herein by reference in its entirety.

### BACKGROUND OF THE INVENTION

1. Field of the Invention

The present invention relates to a computer system having an operating system installed therein, wherein an application program and a kernel are held in different memory spaces and a driver program for controlling an input/output device is held in the memory space where the kernel is held, and a mechanism for enabling a call initiated from the application program, of a function provided by a dynamic link library or other application programs, based on an interface defined in an interface definition language (hereinafter referred to as an IDL). In particular, the present invention relates to application of this mechanism between the application program and the device driver program so as to enable a call from the application program of a function provided by a device driver, or from the device driver of a function provided by the application program or a dynamic link library.

2. Description of the Related Art

Conventionally, in order to control a device driver via an application program when using an OS (Operating System) in which an application program and a kernel are held in different memory spaces, an ioctl system call and a DeviceIoControl system call must be used with respect to UNIX (registered) and Windows NT (registered) systems, respectively.

For example, when a DeviceIoControl system call is used, a file handle, an IO control code, a pointer to an input buffer, an input buffer size, a pointer to an output buffer, an output buffer size, a pointer to an integer to which an output byte number is to be returned, and a structural pointer for an overlap I/O are respectively designated as first, second, third, fourth, fifth, sixth, seventh, and eighth arguments.

For the designation, it is determined that the third and fifth arguments must be given LPVOID-type data. In actual practice, pointers of an appropriate type according to the IO control code for the second argument must be given to the third and fifth arguments. However, because static checking as to whether the types of the given arguments are appropriate is not possible, data of an erroneous type, if given, will not be detected at the time of compiling. Moreover, as no means for detecting a data type in performing a system call is available, an error may not be detected unless it is detected in some other situation. This obstructs improvement of software reliability.

FIG. 15 shows an example program for use in explaining a conventional control program. While referring to the drawing, an example of a program for controlling an input/output device, using a DeviceIoControl system call will be described. In the example of FIG. 15, all necessary arguments to execute “setSpeed” function (speed setting) are initially completed before a DeviceIoControl system call is applied.

FIG. 16 shows an example of a program for explaining a conventional device driver program. This device driver program is to be retrieved when a DeviceIoControl system call is applied relative to a servo control device. The device driver program employs different processes depending on the contents of ioctl codes. For IOCTL_SVC_SET_SPEED, for example, all relevant arguments are completed before a “setSpeed” retrieving function is applied.

As described above, in order to execute “setSpeed” function relative to a servo control device, on a caller side, all arguments necessary for a DeviceioControl system call to call a retrieving function must be first completed. This procedure is complicated, and no static check is performed relative to the arguments.

Meanwhile, on a called side, appropriate device driver processing according to the content of an ioctl code must be selected, and appropriate arguments must be extracted and appropriate output value must be set according to the selected processing. This also requires a complicated program.

Although these programs can be uniquely created once a desired function to call and input or output for the function of interest are determined, these programs must be tailored for every time it becomes necessary because interface definition is not defined.

Here, COM (Component Object Model) from Microsoft, for example, is available as a mechanism for enabling a call initiated from an application program, of a function provided by a dynamic link library or other application program. COM, which was originally directed at component objects, has a function call mechanism for use in operating component objects.

According to COM, an interface is defined using an interface definition language (IDL), so that a function can be called from an application program based on the defined interface. This can ensure separation of implementation and interface, so that larger freedom in combination of applications and device drivers can be ensured, and software maintenance capability can be significantly improved.

Although separation of implementation and interface has been employed in a conventional device control program, such as in COM, such programs continue suffer from the above-described problems as separation of implementation and information is inevitable in an OS where an application program and a device driver program are held in different memory spaces.

Moreover, an OS in which an application program and a kernel are stored in different memory spaces does not provide a mechanism for enabling a call initiated from a device driver, of a function provided by an application program. Therefore, even when data storage in a database system is desired in device driver program processing in order to collect history information, this is not readily achievable as no general-purpose interface for enabling a call initiated from the device driver, of data storage function provided in the application program side is provided by the OS.

As described above, conventionally, no function is provided for allowing a device driver to directly use a function, such as a database and graphical user interface, which is provided on an application program side.

### SUMMARY OF THE INVENTION

The present invention was conceived in view of the above. The present invention first provides a means for enabling device control when an OS where an application program and a device driver are held in different memory spaces is used. The device control is achieved using an interface definition for device control, which is defined in an IDL, and employing a manner similar to that which is employed by a mechanism for enabling a call initiated from an application program, of a function provided by a dynamic link library or other application program.

The present invention additionally provides a means for enabling a call initiated from a device driver, of a function provided by an application program or a dynamic link library.

According to the present invention, an interface for device control is defined in an IDL, and a program for relaying a function call is provided between an application program and a device driver, so that a function call initiated by an application program and addressed to a device driver and that by a device driver and addressed to an application program or a dynamic link library can be attained. Moreover, a part of the relay program for performing such a function call can be automatically created by a special ILD compiler based on the interface.

The “special IDL complier” refers to a CRAD compiler (Component Object Invoking Repeater between Application and Device-driver), which is a relay device for relaying a call relative to a component object between an application program and a device driver program.

As described above, according to an interface method for a device driver of the present invention, as a function call relative to a device driver program can be carried out based on an interface definition, installation and interface can be maintained separate from each other. This can enhance freedom to combine different applications and device drivers.

Further, a call relay proxy and a call relay stub for relaying a function call initiated from an application side and addressed to a device driver side, or vice versa, can be automatically created by a CRAD compiler based on an interface definition. This can significantly improve software maintenance capability.

### BRIEF DESCRIPTION OF THE DRAWINGS

Preferred embodiments of the present invention will be described in detail based on the following figures, wherein:

FIG. 1 is a block diagram showing a device for implementing the present invention;

FIG. 2 is a diagram showing a structure of a program for calling a function provided on a device driver side from a Windows (registered) application side;

FIG. 3 is a diagram showing a structure of a program for initiating calling a function provided on Windows (registered) application side from a device driver side;

FIG. 4 is a flowchart for explaining an operation of a CRAD compiler;

FIG. 5 is a diagram showing an example of program list for an example of an interface definition for a servo controller;

FIG. 6 is a flowchart for explaining an operation of a relay proxy to execute a “setSpeed” retrieving function;

FIG. 7 is a flowchart for explaining an operation of a relay stub to execute a “setSpeed” retrieving function;

FIG. 8 is a flowchart for explaining an operation of a call relay driver;

FIG. 9 is a flowchart for explaining an operation of a call relay demon;

FIG. 10 is a diagram for explaining a structure of a call packet in a first embodiment of the present invention;

FIG. 11 is a diagram for explaining a structure of an output packet in the first embodiment of the present invention;

FIG. 12 is a diagram showing an example of a program list for an example of an interface definition for a message box;

FIG. 13 is a flowchart for exampling an operation of a relay proxy to execute a “SendMessage” retrieving function;

FIG. 14 is a flowchart for explaining an operation of a relay stub to execute a “SendMessage” retrieving function;

FIG. 15 is a diagram showing an example of a program for explaining a conventional control program; and

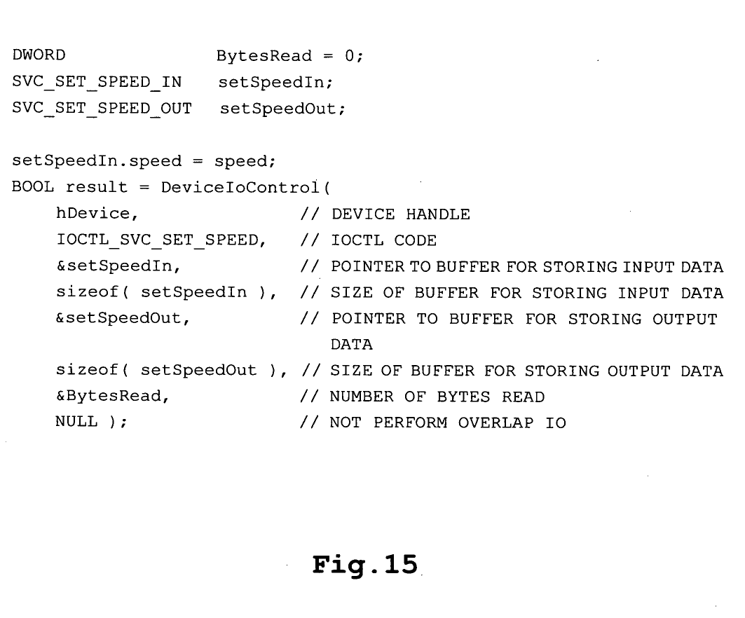

FIG. 16 is a diagram showing an example of a program for explaining a conventional device driver program.

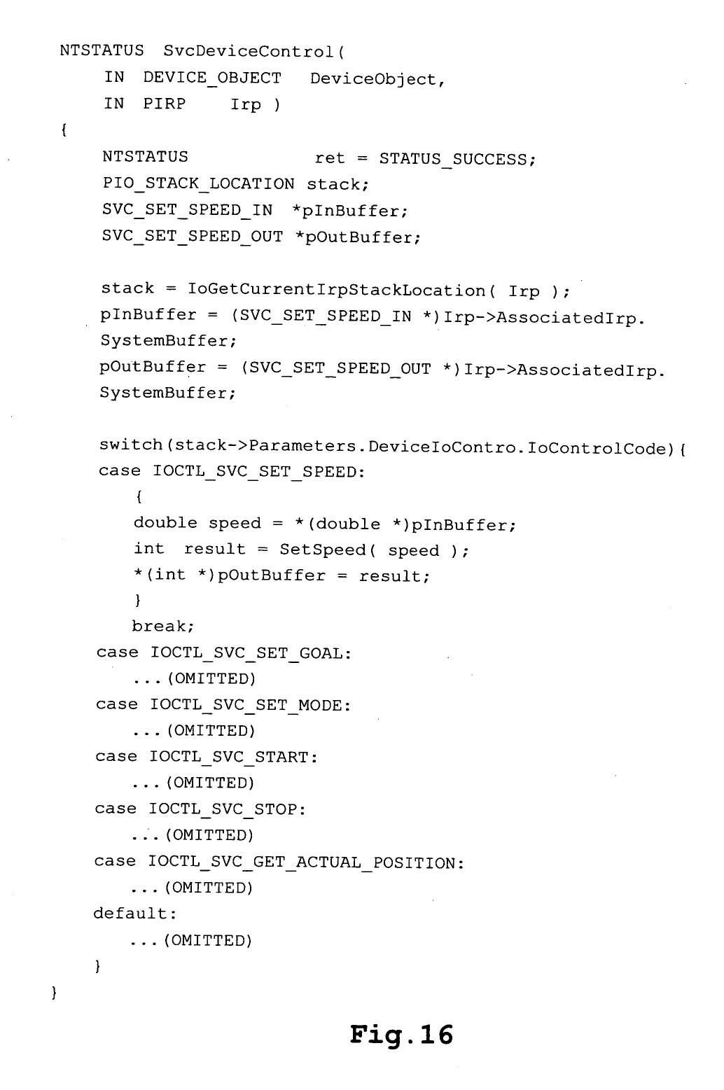

### DESCRIPTION OF THE PREFERRED EMBODIMENTS

In the following, embodiments of the present invention will be described with reference to the accompanied drawings.

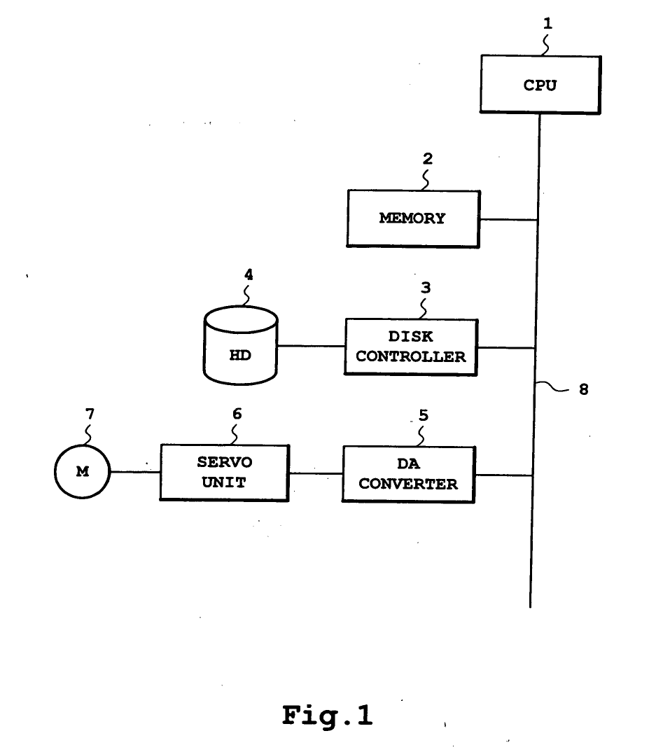

FIG. 1 is a block diagram showing an example of a device for implementing the present invention. A CPU (Central Processing Unit) 1 is connected, via a system bus 8, to a memory 2, a disk controller 3, and a DA converter 5, and the DA converter 5 is connected, via a servo unit 6, to a servo motor 7. The CPU 1 incorporates a memory management unit (not shown) to support a plurality of memory spaces, and to allocate, and manage, in different memory spaces, an application program, which is stored in the hard disk 4 and loaded to the memory 2 to be executed by the CPU 1, and a device driver program, which is implemented as being stored in the memory space in the operating system where the kernel is held. The operating system is stored in the hard disk 4 and loaded to the memory 2 to be executed by the CPU 1.

As a control program for the DA converter 5 is stored in a memory space different from that for the application program, the DA converter 5 cannot be directly accessed and operated via the application program, and must be operated via a device driver program.

Here, it should be noted that the description in this embodiment refers to an illustrative case where Windows (registered) is used as an operating system and COM is used as a mechanism for enabling a call initiated from an extent application program, of a function provided by a dynamic link library and/or other application programs.

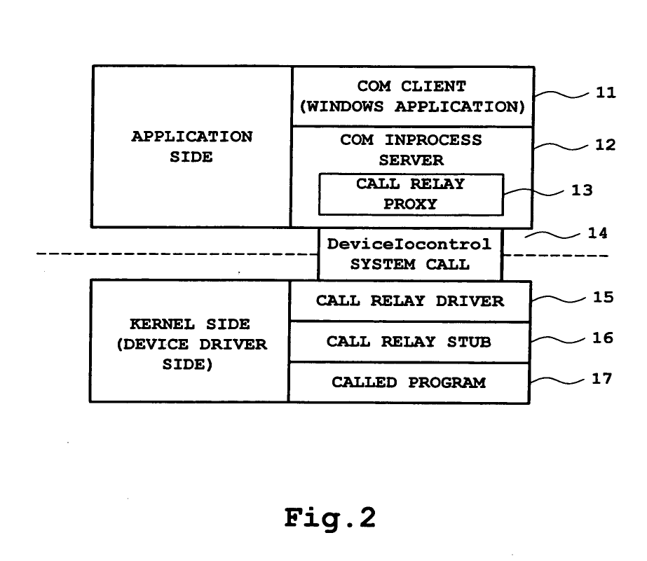

FIG. 2 is a block diagram showing a program structure of a call mechanism according to the present invention. The program structure comprises an application-side program group and a kernel-side program group which includes a device driver.

A COM client 11 is a software which serves as a client relative to COM, which is a software component mechanism implemented in the Windows (registered) operating system. A COM in-process server 12 is implemented as a dynamic link library, and operates in response to a request from the COM client 11. The COM in-process server 12 incorporates a call relay proxy (Proxy) 13.

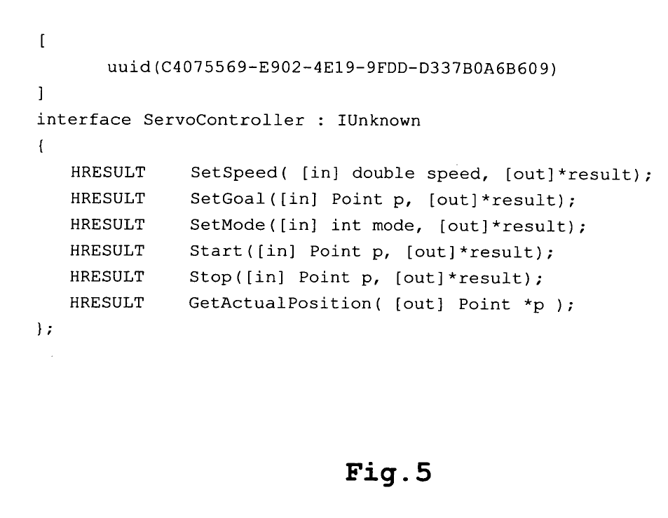

FIG. 5 is a diagram showing an example of a program list of an interface definition for a servo controller. An interface definition, such as is shown in FIG. 5, is defined in an IDL and prepared for the COM in-process server 12, so that the COM client 11 can apply a function call relative to the COM in-process server 12 based on the interface definition.

The program component shown in FIG. 5 is not a complete COM interface definition based on the IDL, and but is only an essential portion of an interface definition, specifically, describing a hexadecimal number which serves as a uuid (Universally Unique Identifiers) indicative of the type of the interface, and defining six functions, including “setSpeed” function, for servo control.

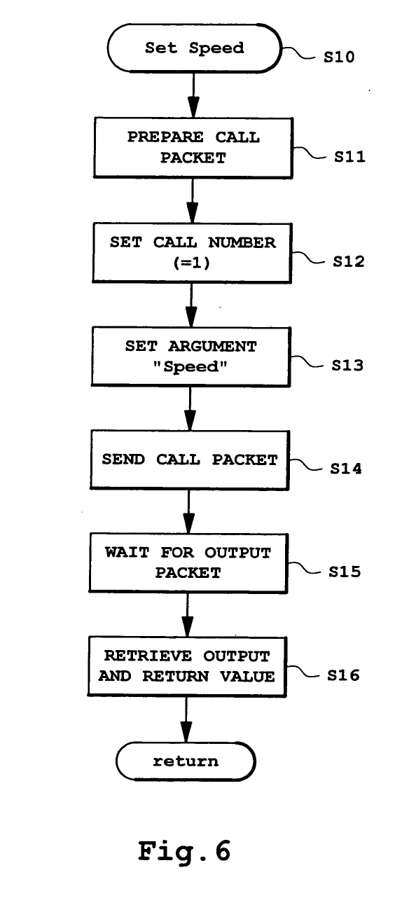

FIG. 6 is a flowchart for explaining an operation of a relay proxy (program) in execution of a “setSpeed” retrieving_function, that is, relaying a call for “setspeed” function among_functions defined in the interface definition shown in FIG. 5. In the following, an operation of the call relay proxy 13 will be described with reference to this flowchart.

When the COM client 11 calls a “setSpeed” retrieving function, “setSpeed” retrieving function is retrieved from the call relay proxy 13 in the COM in-process server 12 (step S10). Subsequently, for preparation, a call packet is initialized by ensuring a necessary memory region in itself (step S11) . Then, a call number is set to the call packet (step S12) . In this example, call number “1” is set as “setSpeed” function is listed first in the function list in the interface definition. Thereafter, an actual argument value for “Speed” argument for “setSpeed” function is set to the call packet (step S13).

With the above, a call packet is completed. This call packet is then sent out to the device driver side (step S14). That is, the call packet is forwarded by the DeviceIOControl system call 14 from the memory space on the application side to that in the device driver side. After sending out the call packet, the call relay proxy 13 is put in a waiting state until it receives an output call from the device driver side, leaving subsequent processing to the call relay driver 15 and so forth on the device driver side (step S15).

On the device driver side, after receipt of the call packet, a proper setting output and a return value are set to an output packet, and then “setSpeed” function is completed. It should be noted that similar processing as that which is described above in connection with “setSpeed” function is performed relative to the other functions defined in the interface definition shown in FIG. 5.

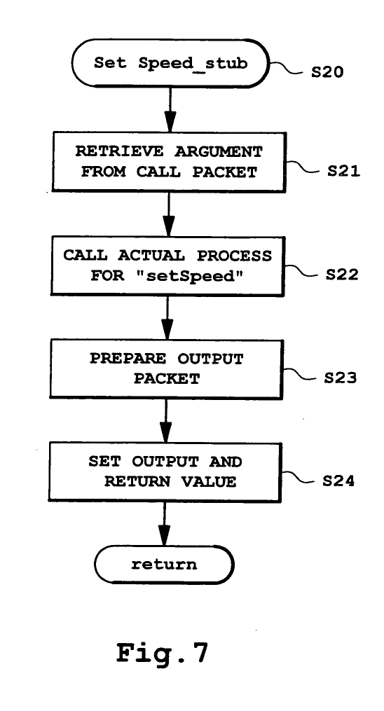

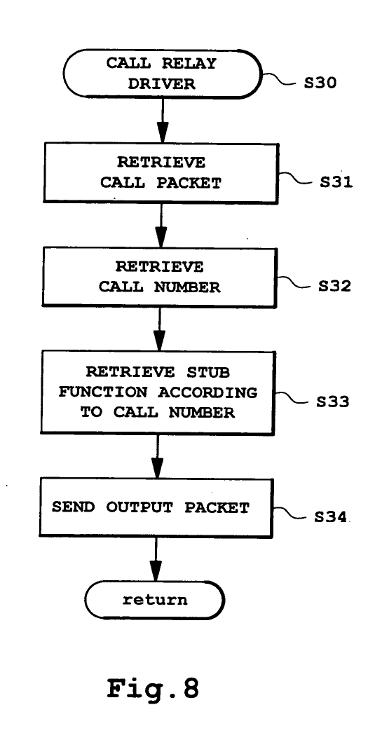

FIG. 8 is a flowchart for explaining an operation of a call relay driver 15. In the following, with reference to FIG. 8 and additionally FIGS. 2 and FIG. 7 (described later), an operation of the call relay driver 15 will be described.

After step S15 in FIG. 6, where the relay proxy 13 is put in a waiting state, as described above, on the device driver side, a call relay driver 15 is retrieved (step S30 in FIG. 8). Then, after receiving the call packet sent from the application side (step S31), a call number is read out from the received call packet (step S32) and a stub function, that is, “setSpeed” function in this case, is retrieved according to the call number (step S33). Then, the call packet is forwarded as an argument to the call relay stub 16 so that the call relay stub 16 can execute processing for the retrieved stub function, using the argument. Thereafter, the call relay stub 16 outputs an output packet, which is then returned to the call relay proxy 13 (step S34).

Here, referring to FIG. 7, the call relay stub 16 is retrieved (step S20 in FIG. 7, corresponding to S33 in FIG. 8), and, thereafter, “argument speed” set by the COM client 11 is extracted from the call package, which is given as an argument by the call relay driver 15 (step S21). Then, “setspeed” program, corresponding to a called program 17, is retrieved (step S22) and “setSpeed” function is executed. After execution of “setSpeed” function, an output packet to serve as a vessel in returning a return value of “setSpeed” function is prepared (step S23), and the return value is set to the output packet (step S24). With the above, operation of the relay stub 16 is completed.

It should be noted that similar processing as that which is described above in connection with “setSpeed” function is performed relative to the other functions listed in the interface definition shown in FIG. 5. It should also be noted that, in the case where a function accompanies an output (e.g., information from an external element), as is different from “setspeed” function, which accompanies no output, the output is also set to the output packet at step S24 in FIG. 7.

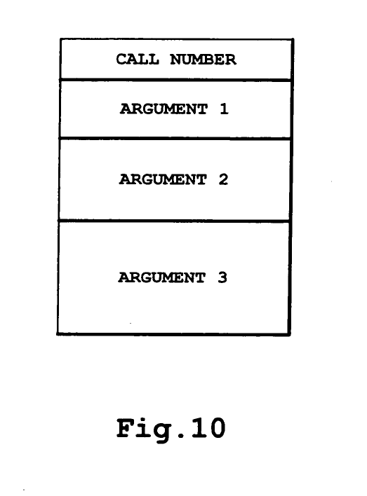

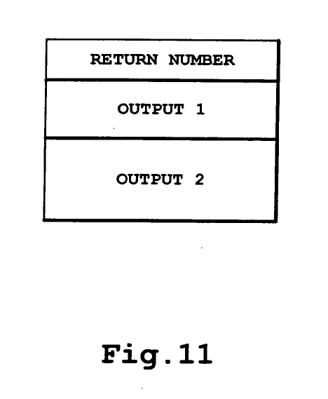

FIG. 10 shows a structure of a call packet in the first embodiment, while FIG. 11 shows an output packet in the first embodiment. A call packet contains a call number, which is set at step S12 in FIG. 6, and an argument, which is set at step S13. It should be noted that the number of arguments to be set in a call packet is not limited to one through three, as shown in FIG. 10, and may vary according to the actual number of arguments. Also, the number of return values and outputs to be set in an output packet, which are set at step S24 in FIG. 7, may vary according to the actual number of argument.

As described above, in response to a call for “setspeed” function sent from the COM client 11 (Windows (registered) application), “setspeed” function is called through the call relay proxy 13, the call relay driver 15, and the call relay stub 16 to be retrieved from the called program 17, and a return value is retuned to the application side.

It should be noted that the called program 17 and the call relay driver 15 can be implemented as different device drivers. This can ensure separation of implementation change and interface change, and thus improve software maintenance.

Here, in general, the COM in-process server 12, the relay proxy 13, and the call relay stub 16 must be created every time the content of the interface definition, such as is shown in FIG. 5, is changed, and these elements can be automatically created using a CRAD compiler in this embodiment.

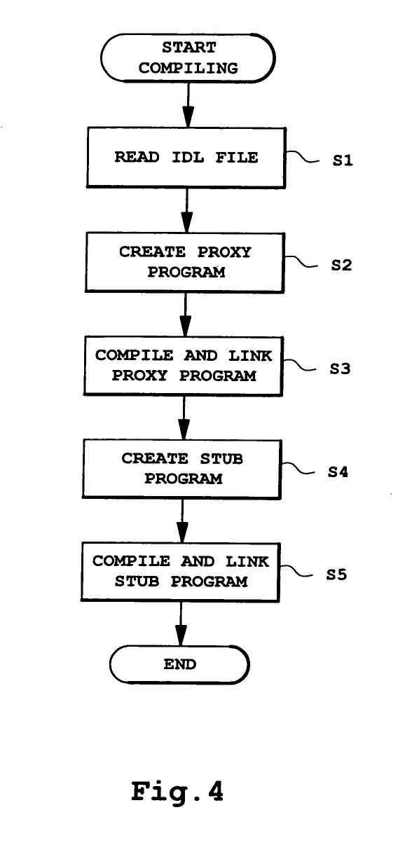

FIG. 4 is a flowchart for explaining an operation of a CRAD compiler.

The CRAD compiler having been activated first reads an IDL file designated (step S1), and then creates a proxy program based on the read IDL file (step S2) . Thereafter, the CRAD compiler compiles and links the resultant proxy program (step S3), whereby the COM in-process server 12 and the call relay proxy 13 are completed.

Creation of the proxy program by the CRAD compiler based on the interface definition can be automatically achieved as the processing described in the flowchart of FIG. 6 can be carried out when in what position in the function list in the interface definition the function of interest is listed, which is indicated by a call number, and the number and type of the argument contained in the interface definition are determined.

Thereafter, a stub program is created based on the interface definition (step S4) and compiled and linked (step S5), whereby the call relay stub 16 is created.

As described above, function call relaying programs on the application and kernel sides are created at steps S2 and S4, respectively.

It should be noted that processing at steps S3 and S5 may not necessarily be carried out by a CRAD compiler, and the programs may be compiled and linked at the time when an application or device driver program are compiled and linked.

FIG. 7 shows a flowchart for explaining operation of a relay stub when “setSpeed” retrieving function is executed. As processing described in the flowchart of FIG. 7 can be carried out when the type of a return value and the number and type of an output are determined, creation of a stub program based on the interface definition can be automatically achieved.

It should be noted that, although it is described in the above that a program for the call relay stub 17 is defined so as to carry out the processing described in the flowchart of FIG. 7, the program may alternatively be defined so as to merely output data concerning the number and type of an argument and information on a return value so that the call relay driver 15 can retrieve a called program based on the data.

In the following, a second embodiment of the present invention will be described.

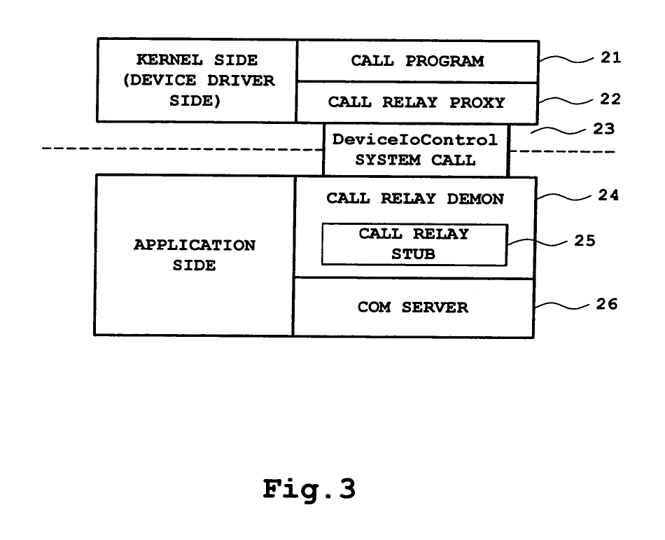

FIG. 3 is a diagram showing a structure of a program for calling, initiated from a device driver, a function provided on the Windows (registered) application side. While a function call initiated by the COM client 11 on the Windows (registered) application side and addressed to a function provided on a device driver side is described with reference to FIG. 2 in the above, in the following, a function call initiated from the device driver side and addressed to Windows (registered) application side will be described with reference to FIG. 3.

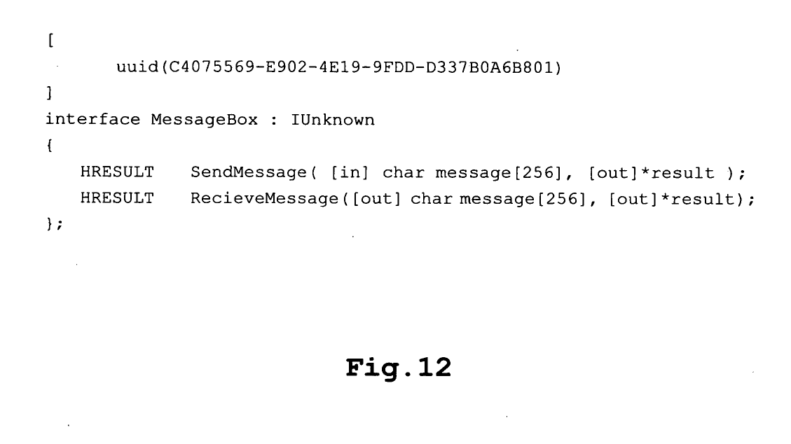

FIG. 12 shows an example of a program list for an example of an interface definition for a message box. The COM server 26 provides an interface function defined in an IDL, as shown in FIG. 12.

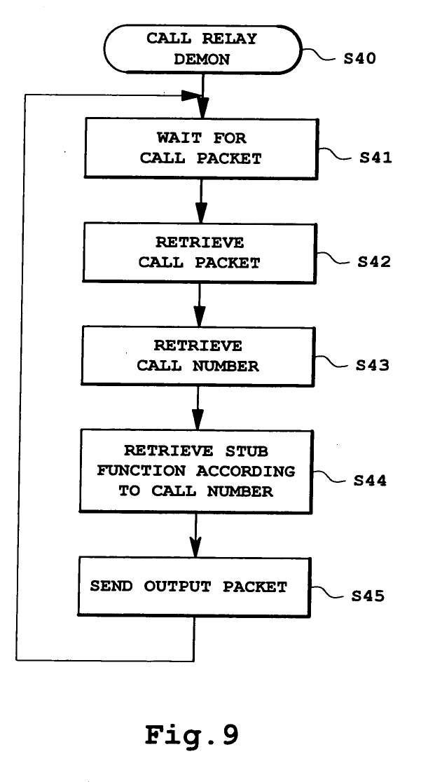

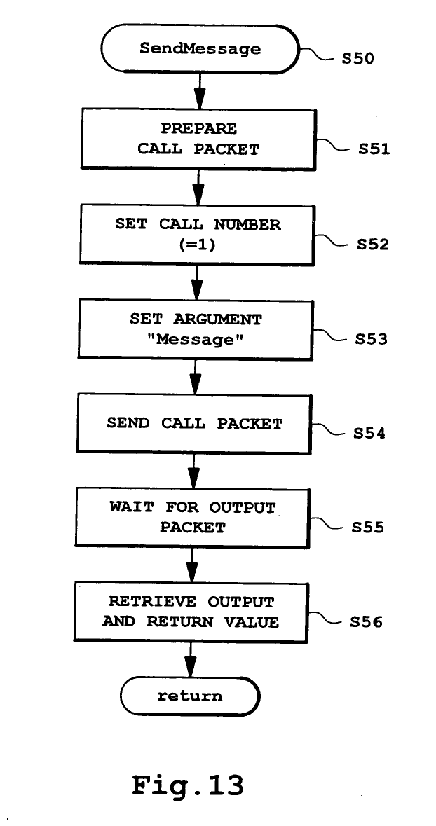

While taking as an example a case where “SendMessage” retrieving function, as shown in FIG. 12, is applied, an operation of a call relay proxy 22 is described with reference to FIG. 13. Also, an operation of a call relay demon 24 is described with reference to FIG. 9.

Referring to FIG. 13, the call relay proxy 22 begins operating when the call program 21 calls “SendMessage” function (step S50) . Initially, for preparation, a call packet is initialized by ensuring necessary memory in itself (step S51). Then, a call number is set to the call packet (step S52) . In this example, call number “1” is set as “SendMessage” function is listed first in the function list in the interface definition. Further, an actual argument value for a “SendMessage” function is set to the call packet (step S53). With the above, a call packet is completed. This call packet is sent out to the device driver side (step S54).

It should be noted that, in transmission of a call packet, the call packet is only copied to a memory region in the call relay proxy 22, and not actually sent to the call relay demon 24. This is because DeviceIoControl system call 23 is a call which can be initiated from an application side and addressed to the kernel side, and does not allow the call relay proxy 22 to directly call a function of the call relay demon 24. Receiving operation of the call relay demon 24 will be described later.

After sending out the call packet, the call relay proxy 22 is put in a waiting state until it receives an output call from the device driver side, leaving subsequent processing to the call relay driver 24 and so forth on the application side (step S55)

On the application side, after receipt of a call packet from the driver side, a proper output and return value are set to an output packet, and “setSpeed” function is completed.

It should be noted that, while operation of the call relay proxy 22 and the call relay demon 24 is described in the above in connection with “setspeed” function, similar operation is carried out with respect to “RecieveMessage” function shown in FIG. 12.

Here, referring to FIG. 9, a call relay demon 24 must_be activated in advance as an individually operating program, (step S40) as is different from the call relay driver 15 (step S30 in FIG. 8) , and placed in a waiting mode until arrival of a call packet from the kernel side (step S41). The call relay demon 24 in the waiting mode monitors the call relay proxy 22 sending a call packet by means of the DeviceIoControl system call 23 (step S54 in FIG. 13)

This is a general restriction imposed on an operating system where memory spaces for application and device driver sides are managed separate, as the program on the application side cannot be executed while taking over the context of arguments on the device driver side.

When a call packet arrived at the application side is detected, the call packet is extracted (step S42), and a call number is extracted from the call packet (step S43). Then, a stub function is retrieved according to the call number (step S44).

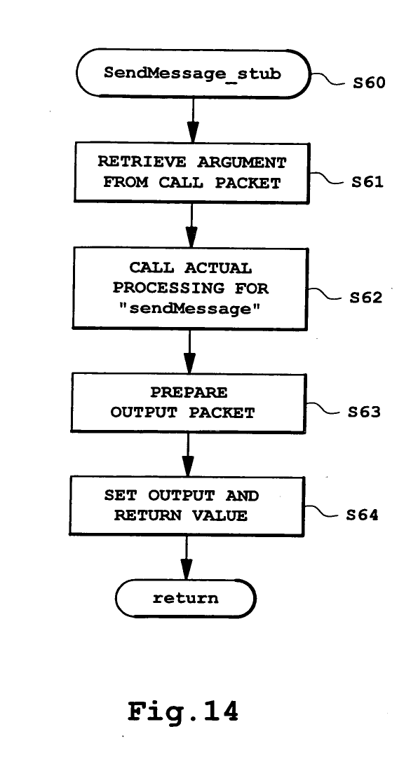

Here, referring to FIG. 14, the call relay stub 25 begins operating when the stub function is retrieved in this case (step S60). Then, an argument is extracted from the call packet (step S61), and actual processing for “SendMessage” function is retrieved (step S62). When actual processing for “SendMessage” function is completed, an output packet is prepared (step S63), and an output and a return value are set to the output packet (step S64). With the above, an operation in execution of a stub function for “SendMessage” function is completed.

Thereafter, the call relay demon 24 resumes processing to send out an output packet (step S45 in FIG. 9). Upon completion of the above operation, the call relay demon 24_returns to step S41 to be again put in a waiting mode for arrival of a call packet.

It should be noted that structures of call and output packets in the second embodiment are similar to those in the first embodiment (FIGS. 10 and 11).

As described above, in response to a call “SendMessage” function sent from the call program 21, “SendMessage” function is called through the call relay proxy 22 and the call relay stub 25 to be retrieved from the COM server 26. Then, a return value is returned.

It should be noted that the call program 21 and the call relay proxy 22 may be implemented as separate device drivers. This can ensure separation of implementation change and interface change separate, and thus improve software maintenance.

FIG. 12 is a diagram showing an example of a program list for an example of an interface definition for a message box. Each time the content of the interface definition is changed, the call relay proxy 22 and the call relay stub 25 must be recreated. These can be automatically created by a CRAD compiler in the same procedure as that which is described above with reference to FIG. 4. In such a case, however, because the proxy program operates on the kernel side while the stub program operates on the application side, an output must be changed from that shown FIG. 4 because a usable system call is different.

As described above, while taking as an example a device driver for controlling a servo motor 7 through a servo unit 6, connected via the DA converter 5, the present invention is described with reference to the interface, such as is shown in FIG. 5, for the device driver. It should be noted that application of the present invention is not limited to a servo motor, and that the present invention can be applied to various other device drivers. Moreover, application of the present invention is not limited to an interface definition such as is shown in FIG. 5 or 12, and the present invention can be applied to various other interface definitions.

Further, although illustrative embodiments of the present invention are described in the above referring to examples wherein Windows (registered) and COM from Microsoft are used, application of the present invention is not limited to the examples, and the present invention can also-be applied also to other operating systems, such as UNIX (registered), and in conjunction with a framework for component objects, such as XPCOM, based on other IDLs.

Still further, although DeviceIOControl and ioctl are noted as examples of a system call to use in controlling an input/output device in the above, these are not limiting examples, and other system calls, such as read and write system calls, for example, may be used in sending call and/or output packets.

It should be noted that, as understood in conjunction with the description of the present invention, any program which is caused to be stored, by the device driver program, in the memory space where the kernel is held is considered to be a device driver program.

1. An interface method for a device driver based on an interface definition language, which is employed in a computer system having an operating system in which an application program and a kernel are held in different memory spaces and a device driver program for controlling an input/output device is stored in the memory space where the kernel is stored, and a mechanism for enabling a function call initiated from the application program and addressed to a dynamic link library or other application programs by utilizing a partial program created based on interface information which is defined using an interface definition language, the interface method comprising:
a definition step of defining interface information for the device drive to control the input/output device, based on the interface definition language; and
an interface definition language compiling step of compiling, using an interface definition language compiler, the interface information defined at the definition step,
wherein
the interface definition language compiling step includes an application-side program creation step of creating an application-side program for relaying a function call based on a system call for controlling the input/output device, in which a mechanism for enabling a function call initiated from the application program and addressed to the dynamic link library or other application programs is incorporated into, and made usable in, the application-side program; and a kernel-side program creation step of creating a kernel-side program for relaying a function call based on the system call for controlling the input/output device, and
the application-side program is allowed to perform a function call addressed to a device driver of the input/output device based on the interface information defined at the definition step.

2. The interface method according to claim 1, wherein the kernel-side program is implemented as a device driver different from the device driver program for controlling the input/output device.

3. An interface method for a device driver based on an interface definition language, which is employed in a computer system having an operating system in which an application program and a kernel are held in different memory spaces and a device driver program for controlling an input/output device is stored in the memory space where the kernel is stored, and a mechanism for enabling a function call initiated from the application program and addressed to a dynamic link library or other application programs by utilizing a partial program created based on interface information which is defined using an interface definition language, the interface method comprising:
a compiling step of compiling interface information for the dynamic link library or an application program, which is defined based on the interface definition language,
wherein
the interface definition language compiling step includes an application-side program creation step of creating an application-side program for relaying a function call based on a system call for controlling the input/output device, in which a mechanism for enabling a function call initiated from the application program and addressed to the dynamic link library or other application programs is incorporated into, and made usable in, the application-side program; and a kernel-side program creation step of creating a kernel-side program for relaying a function call based on the system call for controlling the input/output device, and
a function call initiated from the device driver and addressed to the dynamic link library or other application programs is able to be made.

4. The interface method according to claim 3, wherein the kernel-side program for relaying a function call based on a system call for controlling an input/output device, which is created by an interface definition language compiler, is implemented as a device driver different from a device driver program for controlling the input/output device.

5. The interface method according to claim 3, wherein a program for causing a called program to be independently operated is provided, and the called program monitors a state of the kernel-side program, and receives a function call addressed to the dynamic link library or other application programs, which is sent from the device driver via the kernel-side program.
